(19) United States
(12) Patent Application Publication
(10) Pub. No.: US 2025/0319577 A1
(43) Pub. Date: Oct. 16, 2025

(54) Fastener Tightening Control Device and Method for Testing the Same

(71) Applicant: LISI AEROSPACE, Paris (FR)

(72) Inventors: Benoit REGNARD, Les Clayes Sous Bois (FR); Clément ROUSSEAU, Osny (FR); Florent DELAGE, Clamart (FR); Christophe PAYARD, Rueil-Malmaison (FR); Martial BROUCKE, Delincourt (FR)

(73) Assignee: LISI AEROSPACE, Paris (FR)

(21) Appl. No.: 19/171,858

(22) Filed: Apr. 7, 2025

(30) Foreign Application Priority Data
Apr. 10, 2024 (FR) 2403686

(51) Int. Cl. B25B 23/147

(52) U.S. Cl. CPC B25B 23/147

(57) ABSTRACT

A device, for controlling the tightening tension of a fastener, that includes a rod with two opposite flat faces, an assembly device capable of joining to the rod, and a probe including a probe body, with a frontal face capable of coming into contact with a flat face of the rod, and a transducer attached to the probe body capable of sending and/or receiving ultrasound waves. The rod has a first locking element and the probe has a second locking element capable of cooperating with said first locking element.

### BACKGROUND

The present invention relates to a device for controlling the tightening tension (or “tension”) exerted on the rod of a fastener of the type comprising a rod, extending along a first axis; the rod comprising an assembly element, arranged on a first radial surface of said rod; the rod comprising a first and a second flat faces, perpendicular to the first axis and disposed respectively at a first and a second end of said rod; the control device also comprising: an assembly device, capable of joining to the assembly element of the rod to form the fastening; and a probe comprising: a probe body comprising a first frontal face, capable of coming into contact with the first or second flat face of the rod; and a transducer, attached to the probe body, said transducer being capable of sending and/or receiving ultrasound waves.

The invention applies particularly, but not exclusively, to the tightening control of aircraft fasteners.

In the aeronautical field, it is useful to know the tightening tension of an installed fastener, especially a screw/nut type fastener. In particular, it is useful to be able to control the evolution over time of said tightening tension, in order to plan maintenance operations.

In addition, it is useful to install such fasteners by applying a tightening tension corresponding to a target value.

Document WO2024110510, on behalf of the Applicant and which is incorporated herein by reference, describes a control device as described above. Such a control device makes it possible to define the tightening tension in the fastener by analyzing ultrasonic waves passing through the fastener.

However, to be effective, the transmission of ultrasonic waves between the probe and the rod must be optimal. It is often necessary to use a liquid couplant, such as a gel, at the interface of the probe and the rod, which complicates the implementation of the process.

Furthermore, in the above-mentioned application, the probe is connected to the rod by axial translation. Assembly clearance is required, which leads to uncertainty about the position of the transducer in relation to the rod axis.

### SUMMARY

In order to solve these problems, the invention relates to a control device of the above type, wherein: the rod has a first locking element; and the probe has a second locking element, capable of mechanically cooperating with said first locking element, so as to block an axial displacement of the probe with respect to the rod and to apply the first frontal face of the probe body against the first or second flat face of the rod.

In addition to other advantageous aspects of the invention, the control apparatus comprises one or more of the following features, taken separately or in all technically feasible combinations:
the control device also includes a layer of solid coating on the first frontal face of the probe body, said coating being capable of improving acoustic transmission between the probe body and the rod;
the rod includes an enlarged head, arranged at the first end of the said rod;
the rod assembly element is a threaded portion, arranged at the second end of the said rod; and the assembly device is a nut;
the probe body extends along a second axis between the first and a second frontal face, each of the said frontal faces being flat and perpendicular to the second axis, the transducer being in contact with the second frontal face;
the transducer includes a piezoelectric sensor, fixed on the second frontal face of the probe body;
the second frontal face of the probe body is formed by the bottom of a hollowed part in the probe body;
the probe also comprises: a tubular support, comprising an end opened on an axial cavity; and a compression spring, disposed in said axial cavity, a first and second ends of the spring being attached respectively to the probe body and the tubular support; the probe body being mobile in translation in the axial cavity of the tubular support; and wherein the second locking element is carried by the tubular support;
the rod has an axial recess, arranged at one of the first and second ends of the said rod; the first or second flat face of the rod is formed by a bottom of the said axial recess; and the first locking element is carried by the axial recess;
the first and second locking elements are respectively an external thread and an internal thread;
the probe external thread is carried by the probe body;
the first and second locking elements comprise a bayonet notch and a bayonet lug, respectively;
the first and second locking elements comprise respectively: an internal groove, provided in the axial recess of the rod; and at least one locking lug, provided on the tubular support of the probe, the tubular probe support comprises at least one flexible tab, the flexible tabs carrying the locking lugs; the probe further comprises a sleeve arranged around the tubular support and capable of sliding axially with respect to said tubular support, the sleeve comprising at least one through hole; and the tubular support and the sleeve are movable between a retracted conformation, in which at least one locking lug is disposed inside the sleeve, and an extended conformation, in which the or each locking lug is disposed in the through hole of the sleeve and protruding radially from said sleeve; the device being configured so that, in the extended conformation, the locking lugs are capable of being disposed in the inner groove of the axial recess of the rod, so as to axially lock the probe in said axial recess;
the enlarged head of the rod comprises a second external radial surface arranged around the first axis; said radial surface comprising the first locking element and the first anti-rotation elements;
the open end of the tubular support of the probe comprises second anti-rotation elements, capable of mechanically cooperating with the first anti-rotation elements to lock the rod in rotation with respect to said open end; and the second locking element comprises at least one movable element radially with respect to said open end, between a locked position, in which said moving element mechanically cooperates with the first locking element, and an unlocked position, in which said moving element and said first locking element are away from each other.

The invention further relates to a method for testing the tightness of a fastener by means of a control device as described above, said method comprising: an assembly phase, comprising: the assembly of the rod and the assembly device with structural elements to form the fastener, a tightening tension being applied in the rod; and assembling the second locking element of the probe with the first locking element of the rod, so as to lock the probe axially with respect to the rod and to apply the first frontal face of the probe body against one of the first and second flat faces of the rod with a non-zero pressure; and a phase for measuring the tightening tension, comprising: the generation, by the transducer, of the ultrasonic waves emitted; the reception, by said transducer, of ultrasonic waves reflected by the other of the first and second flat surfaces of the rod; and the processing of the ultrasonic waves received to calculate the tightening tension in the rod.

According to an embodiment of the invention, the assembly of the rod and the assembly device comprises a step for tightening the nut on the threaded portion of the rod; the tightening tension measurement phase is carried out simultaneously with said tightening step; and the tightening of the nut is stopped when a target value of the tightening tension is reached.

### BRIEF DESCRIPTION OF THE DRAWINGS

The invention will become clearer from the following description, given only as an unrestricted example and made with reference to drawings in which:

FIG. 1 schematically represents a control device according to a first embodiment of the invention;

FIG. 2 is a cross-sectional view of a first variant of the realization of an element of the control device in FIG. 1;

FIG. 3 is a cross-sectional view of a second variant of the realization of an element of the control device in FIG. 1;

FIG. 4 is a partial cross-sectional view of a control device according to a second embodiment of the invention;

FIG. 5 is a cross-sectional view of a control device according to a third embodiment of the invention;

FIGS. 6 and 7 are partial views, in perspective, of variants of the realization of the control device in FIG. 5; and

FIG. 8 is a flowchart illustrating the steps of a process for implementing the device in FIGS. 1 and 4-7.

### DETAILED DESCRIPTION OF THE EXEMPLARY EMBODIMENTS

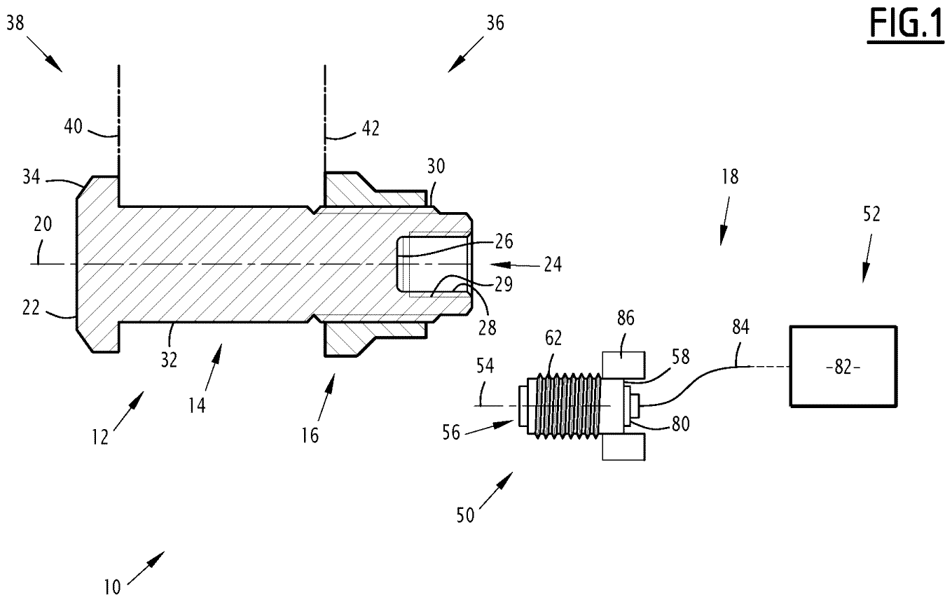

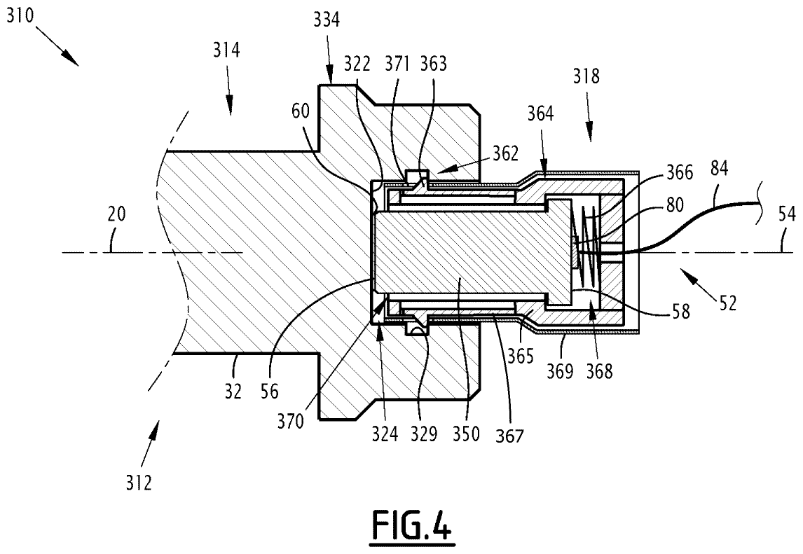

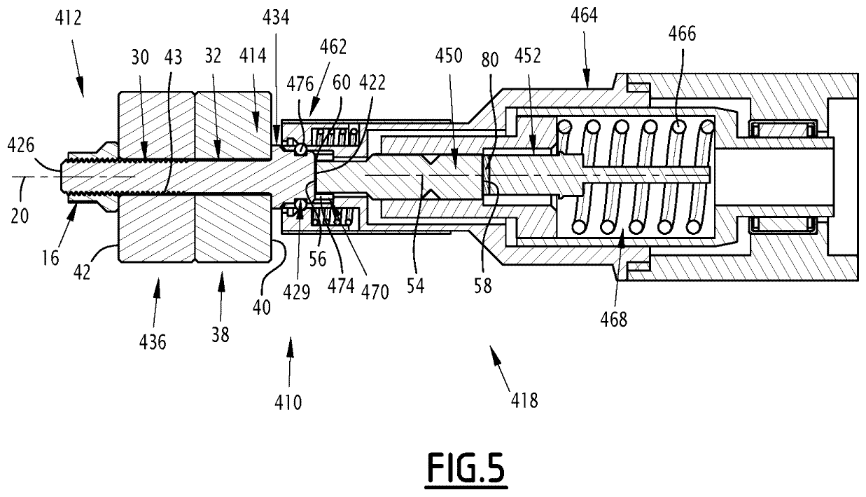

FIG. 1 shows a device 10 for controlling the tightness of a fastener 12, according to a first embodiment of the invention. FIG. 4 shows a device 310 for controlling the tightness of a fastener 312, according to a second embodiment of the invention. FIG. 5 shows a device 410 for controlling the tightness of a 412 fastener, according to a third embodiment of the invention.

Devices 10, 310 and 410 will be described simultaneously below, with the common elements designated by the same reference numbers.

Device 10, 310, 410 comprises: a rod 14, 314, 414; an assembly device 16; and a probe 18, 318, 418. In FIG. 1, only rod 14 and assembly device 16 are shown in cross-section.

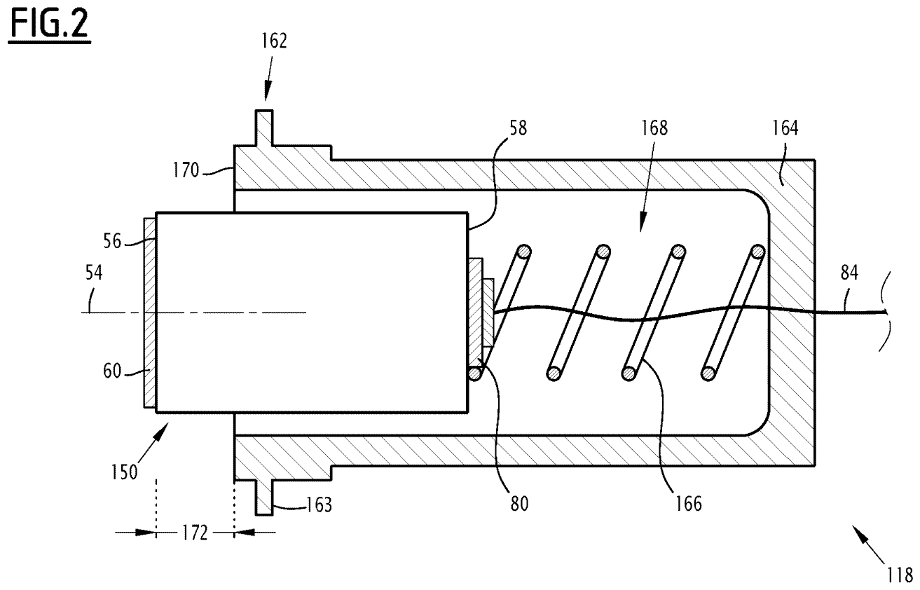

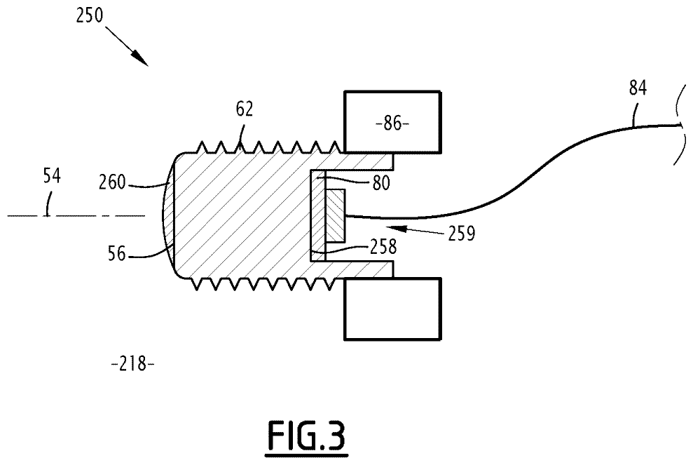

FIGS. 2 and 3 are partial cross-sectional views of a probe 118, 218 according to other embodiments. Probes 118 and 218, are suitable for replacing probe 18 in device 10 in FIG. 1.

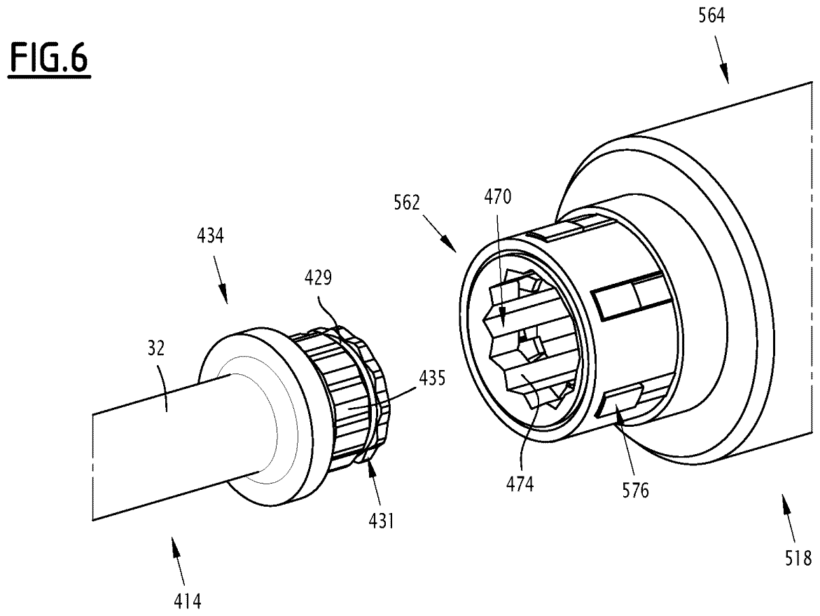

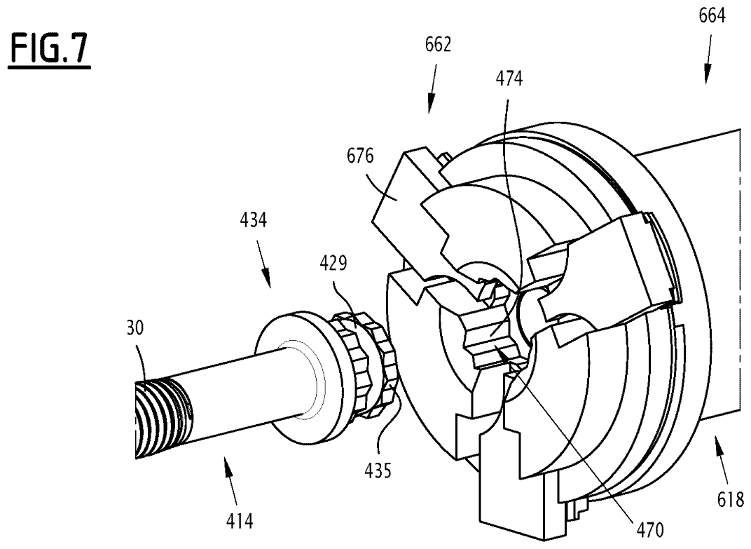

FIGS. 6 and 7 show probes 518 and 618 in other embodiments. The probes 518 and 618 are suitable to replace the probe 418 in the device 410 in FIG. 5. Rod 414 in FIG. 5 is partially visible in FIGS. 6 and 7.

The rod 14, 314, 414 extends along a first axis 20 between a first and a second end. The rod 14, 314, 414 includes a smooth shank 32.

The rod 14, 314, 414 also includes a first flat face 22, 322, 422 and a second flat face 26, 426, perpendicular to the first axis 20 and arranged respectively at the first and second ends of said rod.

In addition, rod 14, 314, 414 includes a first locking element 29, 329, 429 which will be described in more detail below. Preferably, as specified below, the first locking element 29, 329, 429 extends radially, i.e. perpendicular to the first axis 20.

In the embodiments shown, the rod 14, 314, 414 also has a head 34, 334, 434 enlarged, adjacent to the smooth shaft 32. The head 34, 334, 434 forms a radial projection in relation to said shaft 32. In the following description, it is considered that the head 34, 334, 434 is disposed at the first end of the rod 14, 314, 414.

Rod 14, 314, 414 also comprises an assembly element 30, arranged on a first external radial surface of said rod. Assembly element 30 is suitable for cooperating with assembly device 16, so as to form fastener 12, 312, 412 from rod 14, 314, 414 and assembly device 16.

In the embodiments shown, the rod 14, 314, 414 is a screw and the assembly element is a threaded portion 30 of the screw. The threaded portion 30 is aligned with the smooth shank 32 according to the first axis 20, i.e., the threaded portion 30 and the smooth shank 32 are coaxial. The second end of the rod 14, 314, 414 is formed by the threaded portion 30.

According to certain embodiments, rod 14, 314 has an axial recess 24, 324, arranged at one of the first and second ends of said rod; the first flat face 22 or the second 26 flat face of the rod is formed by a bottom of said axial recess; and the first locking element 29, 329 is formed in a portion of the inner surface that defines the axial recess 24, 324.

More precisely, the rod 14 in FIG. 1 has an axial recess 24 arranged at the second end, near the threaded portion 30; and the rod 314 in FIG. 4 has an axial recess 324 arranged at the first end, at the level of the enlarged head 334.

The recess 24, 324 comprises: a flat bottom, perpendicular to the first axis 20 and formed by the first flat face 322 or by the second 26 flat face; and an inner wall 28, arranged around the first axis 20.

Moreover, in the embodiments of FIGS. 1 and 4, the first locking element 29, 329 is formed in a portion of the inner surface that defines the recess 24, 324.

In the embodiment shown in FIG. 1, the first locking element 29 is a thread in the inner wall 28 of the recess 24. In a variant not shown, the first locking element 29 is formed by at least two bayonet notches, arranged in the inner wall 28 of the recess 24 and arranged opposite to the first axis 20.

In the embodiment shown in FIG. 4, the first locking element 329 is an internal annular groove, arranged in the inner wall 28 of the recess 324 around the first axis 20.

In the embodiment of FIGS. 5 to 7, the rod 414 does not include an axial recess and a distance between the first flat face 422 and the second flat face 426 corresponds to a maximum length of said rod 414 along the first axis 20. The second flat face (not shown) of rod 314 in FIG. 4 is similar to the second flat face 426 of rod 414.

Moreover, in the embodiments of FIGS. 5 to 7, the enlarged head 434 of the rod 414 includes a second external radial surface 431, arranged around the first axis 20; and said second radial surface 431 comprises the first locking element 429 and the first anti-rotation elements 435.

More precisely, in the embodiment shown, the first locking element 429 is an annular external groove, arranged in the second radial surface 431 around the first axis 20. The groove is continuous. Alternatively, the groove may be discontinuous.

Preferably, the first anti-rotation elements 435 extend axially on either side of the annular outer groove 429 onto the second radial surface 431. In the embodiment shown in FIGS. 5 to 7, the first anti-rotation elements 435 form a 12-point drive surface for the enlarged head 434 of the rod 414. In addition, other forms of driving surfaces can be used.

As specified above, the assembly device 16 is suitable for joining to the assembly element 30 of the rod 14, 314, 414 to form the fastener 12, 312, 412.

In the embodiment represented, the assembly device 16 is a tapped nut, suitable for joining to the threaded portion 30 of the rod 14, 314, 414.

In particular, fasteners 12, 312, 412 are capable of forming a structural connection 36, 436 with structural elements 38, superimposed in such a way as to present opposite faces. In structural assembly 36, 436, the shaft 32 of rod 14, 314, 414 is arranged in a hole 43 (FIG. 5) of structural elements 38; the head 34 is resting against the first face 40; and the nut 16 is assembled to the threaded portion 30 of the rod and is resting against the second face 42. A tightening tension is applied in rod 14, 314, 414 by tightening nut 16.

The probe 18, 318, 418 of device 10, 310, 410 and probes 118, 218, 518, 618 according to variants of embodiments will be described simultaneously, the common elements being designated by the same reference numbers.

The probe 18, 118, 218, 318, 418 includes a probe body 50, 150, 250, 350, 450 and a transducer 52, 452. The probes 518 and 618 in FIGS. 6 and 7 include a probe body 450 and a transducer 452 similar to the probe 418 in FIG. 5.

In addition, the probe 18, 118, 218, 318, 418, 518, 618 has a second locking element 62, 162, 362, 462, 562, 662.

The probe body 50, 150, 250, 350, 450 extends along a second axis 54 and has a first frontal face 56 and a second 58, 258 frontal face. Each of said frontal faces 56, 58, 258 is flat and perpendicular to the second axis 54.

In the embodiment of FIG. 3, the second frontal face 258 forms the bottom of a hollowed part 259 made in the probe body 250. For example, hollowed part 259 has a cylindrical wall, but the shape of the wall may be different.

Optionally, the probe body 250 includes a cover (not shown), e.g. made of plastic, closing the hollowed part 259.

The probe body 50, 150, 250, 350, 450 is suitable for being disposed in contact with the probe rod 14, 314, 414, so that the first frontal face 56 of said probe body is in contact with the first flat face 322, 422 or the second 26 flat face of said rod.

More specifically, in the embodiment of FIGS. 1 to 4, the probe body 50, 150, 250, 350 is suitable for being disposed in the axial recess 24, 324 of rod 14, 314, so that the first frontal face 56 of said probe body is in contact with the flat bottom of said axial recess, formed by the first flat face 322 or by the second flat face 26 of said rod.

In the embodiment of FIGS. 5 to 7, the probe body 450 is intended to come into contact with the first flat face 422 of the rod 414, carried by the enlarged head 434, as described below.

Preferably, the probe body 50, 150, 250, 350, 450 comprises a layer of solid coating 60, 260, deposited on the first front face 56.

As described below, the coating 60, 260 is suitable for improving acoustic transmission between the probe body 50, 150 and the rod 14, 314, 414. Coating 60, 260 is for example a sheet of tin, silver, copper or an elastomer coupling material such as Aqualene, developed by Innovation Polymers, Canada. The coating 60, 260 is preferentially a material with a malleability at least equivalent to that of tin, such as an elastomer of the NBR, silicone, EPDM type.

In the example in FIGS. 1, 2, 4 and 5, the coating 60 is deposited in the form of a substantially flat layer on the first frontal face 56. In the example in FIG. 3, the coating 260 is deposited in such a convex shape. Coating 260 can be used instead of coating 60.

The second locking element 62, 162, 362, 462, 562, 662 of probe 18, 118, 218, 318, 418, 518, 618 is capable of cooperating with the first locking element 29, 329, 429 of rod 14, 314, 414, so as to block an axial displacement of said probe with respect to said rod. Advantageously, the second locking element 62, 162, 362, 462, 562, 662 extends radially, i.e. perpendicular to the second axis 54.

Specifically, the first locking element 29, 329, 429 and the second 62, 162, 362, 462, 562, 662 locking element are suitable for cooperating with each other in an assembled configuration of said rod 14, 314, 414 and probe 18, 118, 218, 318, 418, 518, 618. In said assembled configuration, the first axis 20 and the second axis 54 are merged and the first frontal face 56 of the probe body 50, 150, 250, 350, 450 is applied against the first flat face 322, 422 or the second flat face 26 of the rod 14, 314, 414. FIGS. 4 and 5 represent the assembled configurations of the rod 314 with probe 318 and the rod 414 with probe 418, respectively.

The rod 14, 314, 414 and probe 18, 118, 218, 318, 418, 518, 618 are movable in rotation relative to each other between the assembled configuration and a free configuration, in which the first locking element 29, 329, 429 and the second 62, 162, 362, 462, 562, 662 locking element are angularly offset from each other. In the so-called free configuration, the rod 14, 314, 414 and probe 18, 118, 218, 318, 418, 518, 618 are thus mechanically decoupled from each other.

The transducer 52, 452 comprises: a sensor 80; an electronics module 82; and a cable 84 for linking.

The sensor 80 is an ultrasonic transceiver, attached to the second frontal face 58, 258 of the probe body 50, 150, 250, 350, 450.

In the embodiment shown in FIG. 3, the hollowed part 259 makes it possible to arrange the first frontal face 56 and the second frontal face 258 of the probe body 250 close to each other. Such a configuration makes it possible to improve the transmission of ultrasonic waves, as described below.

Optionally, the hollowed part 259 can be filled, e.g. with epoxy conductive resin, to adjust the damping and bandwidth of the sensor 80. The integration of the sensor 80 inside the body 250 ensures its protection.

The sensor 80 is preferably a piezoelectric sensor, capable of converting a received electrical signal into an emitted ultrasonic wave, and capable of converting a received ultrasonic wave into an emitted electrical signal. The connecting cable 84 electrically connects the sensor 80 and the electronic module 82. The electronic module 82 is capable of transmitting a first electrical signal to the 80 sensor and analyzing a second electrical signal received from the sensor 80.

In the embodiment shown in FIG. 2, the connecting cable 84 passes through a wall of the tubular support 164 of the probe 118. The electronic module 82 is not shown in FIGS. 2 to 5. The link cable 84 is not shown in FIG. 5.

The embodiment of FIGS. 1 and 3 will now be described in more detail.

In the embodiment of FIGS. 1 and 3, the second locking element 62 of probe 18, 218 is a thread capable of cooperating with the thread forming the first locking element 29.

Similarly, in a variant of the embodiment in FIG. 2, the second locking element 162 is a thread. Eventually, the pitch of such a thread is incomplete, for a “quarter turn” type assembly.

In the case where rod 14 comprises threaded portion 30, the thread forming the second locking element 62, 162 may be in the same direction as that of said threaded portion, or in the opposite direction.

In the embodiment of FIGS. 1 and 3, the thread forming the second locking element 62 is provided on the probe body 50, 250. Preferably, said thread 62 has several full pitches.

Optionally, the probe 18, 118, 218 also includes a gripper element 86, which allows the thread 62, 162 to be screwed into the tapped wall 28 of the axial recess 24. In the embodiments shown in FIGS. 1 and 3, the gripper element has gripping ears 86. The gripping element 86 can be formed by any manual device or by a tool connected to an energy source, capable of connecting to the body of the probe and driving it in rotation in the two opposite directions. The gripper element 86 can be removable or permanently attached to the probe.

The embodiments of FIGS. 2, 4 and 5-7 will now be described in more detail.

In the embodiments of FIGS. 2, 4 and 5-7, the probe 118, 318, 418, 518, 618 also includes a tubular support 164, 364, 464, 564, 664 and a spring 166, 366, 466.

The tubular support 164, 364, 464, 564, 664 comprises an internal cavity 168, 368, 468, extending along the second axis 54 between a first end 170, 370, 470 and a second end. The first end 170, 370, 470 is open.

The spring 166, 366, 466 is a compression spring, arranged in cavity 168, 368, 468 according to the second axis 54. A first end and a second end of the spring 166, 366, 466 are attached respectively: to the probe body 150, 350, 450; and at the support 164, 364, 464, 564, 664, at the level of the second end of the cavity 168, 368, 468.

The probe body 150, 350, 450 is mobile in translation along the second axis 54, in the cavity 168, 368, 468 of the support 164, 364, 464, 564, 664.

In a first position, corresponding to a state of minimum compression of the spring 166, 366, 466, the first frontal face 56 of the probe body 150, 350, 450 is disposed outside the cavity 168, 368, 468 and at a first distance 172 from the first end 170, 370, 470. The first position is visible in FIG. 2.

In the assembled configuration of the probe 118, 318, 418, 518, 618 and rod 14, 314, 414, the first frontal face 56 of probe body 150, 350, 450 is arranged at a second distance from the first end 170, 370, 470 of cavity 168, 368, 468. Said second distance, which is less than the first distance 172, corresponds to a second position of the probe body 150, 350, 450 in relation to the support 164, 364, 464, 564, 664 along the second axis 54. The second position corresponds to a compression of the spring 166, 366, 466 that is higher than that of the first position.

In the embodiment shown in FIG. 2, the second locking element 162 of the probe 118 has at least two bayonet lugs 163, each of which is capable of cooperating with one of the two bayonet notches forming the first corresponding locking element (not shown) in the recess 24 of the rod 14. Said bayonet lugs 163 are attached to the support 164 of the probe 118, near the first end 170 of the cavity 168.

In the embodiment shown in FIG. 4, the second locking element 362 comprises at least one locking lug 363, provided on the tubular support 364 of the probe 318.

More specifically, the support 364 includes: a main portion 365; and at least one flexible tab 367, extending along the second axis 54 between a first end and a second end. The first end is attached to the main portion 365, and the second end carries the locking lug or one of the locking lugs 363.

Preferably, the support 364 consists of at least two flexible tabs 367 and at least two locking lugs 363, which are angularly evenly distributed around the second axis 54.

In addition, in the embodiment shown in FIG. 4, the probe 318 also includes a sleeve 369, arranged around the tubular support 364 and capable of sliding axially with respect to said support. The sleeve 369 includes at least one through hole 371. Preferably, sleeve 369 includes at least two through hole 371, angularly evenly distributed around the second axis 54.

The tubular support 364 and the sleeve 369 are movable between an extended conformation, visible in FIG. 4, and a retracted conformation. In the extended conformation, at least one locking lug 363 is disposed in a through hole 371 of the sleeve 369, projecting radially from said sleeve and from the main portion 365 of the support 364. In the retracted conformation, at least one locking lug 363 is axially separated from the corresponding through hole 371 and arranged inside the sleeve 369. An axial sliding of the sleeve 369 in relation to the support 364 allows the switch from the extended to the retracted conformation and vice versa.

In the assembled configuration of the rod 314 and probe 318, the tubular support 364 and sleeve 369 are in the extended conformation and the locking lugs 363 are arranged in the annular inner groove 329 of the axial recess 324 of rod 314, so as to axially lock probe 318 in said axial recess.

The embodiments of FIGS. 5 to 7 will now be described in more detail.

In the embodiments shown in FIGS. 5 to 7, the first open end 470 of the tubular support 464, 564, 664 of the probe 418, 518, 618 comprises second anti-rotation elements 474, capable of mechanically cooperating with the first anti-rotation elements 435 of the rod 414 in order to block said rod from rotation with respect to said first end 470. Preferably, the second anti-rotation elements 474 have a complementary shape to the drive surface of the head 434 of the rod 414. In the embodiment depicted, the second anti-rotation elements 474 have a substantially 12-sided shape, continuous or discontinuous, arranged in an inner wall of the first open end 470 of the support 464, 564, 664.

Moreover, in the embodiments of FIGS. 5 to 7, the second locking element 462, 562, 662 comprises at least one movable element 476, 576, 676. More precisely, said at least one moving element 476, 576, 676 is capable of moving radially with respect to the first open end 470 of the tubular support 464, 564, 664. In the embodiments shown, the second locking element 462, 562, 662 comprises several moving elements 476, 576, 676, substantially identical and angularly distributed in a regular manner around the second axis 54.

Moving elements 476, 576, 676 are capable of moving between a locked position, particularly shown in FIG. 4, and an unlocked position. In the locked position, the or each moving element 476, 576, 676 mechanically cooperates with the first locking element 429 of the rod 414, so as to block the rod axially with respect to the support 464, 564, 664. In the unlocked position, the movable element 476, 576, 676 and said first locking element 429 are set apart from each other, the rod 414 being free in axial translation with respect to the first open end 470 of the support 464, 564, 664.

In the embodiment of FIG. 5, the moving elements 476 are balls. In the embodiment shown in FIG. 6, the moving elements 576 are lugs, each lug forming the end of a flexible tongue. In the embodiment shown in FIG. 7, the moving elements 676 are elements capable of sliding radially with respect to the support 664.

Specifically, the probes 418, 518 and 618 shown in FIGS. 5, 6 and 7 are described in the above-mentioned document WO2024110510 as fastener tighteners.

A process (or “method”) for implementing device 10, 310, 410 above will now be described.

According to a first embodiment, the method aims to control the tightening tension in fasteners 12, 312, 412. Fasteners 12, 312, 412 are considered to form structural connection 36, 436 with the structural elements 38 described above.

First, the second locking element 62, 162, 362, 462, 562, 662 of the probe 18, 118, 218, 318, 418, 518, 618 is assembled to the first locking element 29, 329, 429 of the rod, so as to axially lock the probe with respect to the rod. The first frontal face 56 of the probe body is thus applied against one of the first and second flat surfaces 26, 322, 422 of the rod with a non-zero pressure.

For example, in the embodiment of FIGS. 1 to 3, threads 62, 162 of probe 18, 118, 218 are assembled to the tapped wall 28 of recess 24 of rod 14. For example, such an assembly of probe 18, 118, 218 with recess 24 of rod 14 is carried out by hand by an operator. The axial pressure between probe 18, 118, 218 and bottom 26 of recess 24 allows good transmission of ultrasonic waves, even in the absence of a gel-type coupling at the interface.

When assembling the probe 18, 118, 218, 318, 418, 518, 618 with the rod 14, 314, 414, the solid coating layer 60, 260 deforms under axial pressure, allowing optimal contact between the probe and the rod. If the probe has a coating 260 with a domed shape, the malleability of the coating makes it possible to compensate for any small misalignments.

In the embodiment of FIGS. 1 and 3, the axial pressure is preferably implemented by applying a tightening torque to the probe body 50, 250, in particular by means of the gripping element 86. For example, such a tightening torque is applied by hand by the operator.

In the embodiments of FIGS. 2, 4 and 5-7, in the assembled configuration of the probe 118, 318, 418, 518, 618 and the rod 14, 314, 414, the spring 166, 366, 466 applies the non-zero pressure between the probe body 150, 350, 450 and the first flat face 322, 422 or the second flat face 26 of the rod. In the embodiment shown in FIG. 2, it is therefore unnecessary to apply a large tightening torque between the support 164 and the recess 24. A bayonet type assembly is thus sufficient, but can be replaced by a thread/tap type assembly as previously described.

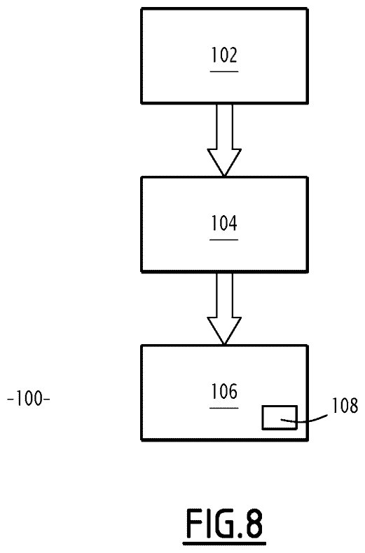

Once the probe 18, 118, 218, 318, 418, 518, 618 and rod 14, 314, 414 have been assembled, a measurement phase 100 is implemented. Said measurement phase 100 is shown schematically in FIG. 8.

In a first step 102 of the measurement phase 100, the transducer 52, 452 generates the first ultrasonic waves, known as emitted ultrasonic waves, at the second frontal face 58, 258 of the probe body 50, 150, 250, 350, 450.

More precisely, during the first stage 102, the electronic module 82 emits a first electrical signal to the sensor 80; and said sensor 80 converts said first electrical signal into said emitted ultrasonic waves.

In a second step 104 of the measurement phase 100, the emitted ultrasonic waves propagate along the second axis 54 to the first frontal face 56 of the probe body 50, 150, 250, 350, 450 and then into rod 14, 314, 414 along the first axis 20. Said ultrasonic waves are then reflected by the first flat face 22 or by the second flat face 426 of the rod 14, 314, 414, which is not in contact with the probe body. This results in second ultrasonic waves, known as received ultrasonic waves, which reach the sensor 80.

Advantageously, a distance between the first frontal face 56 and the second frontal face 58, 258 of the probe body 50, 150, 250, 350, 450 is chosen as small as possible, to limit possible resonance phenomena in the probe body.

In a third step 106 of the measurement phase 100, the received ultrasonic waves are converted by the sensor 80 into a second electrical signal, which is sent to the electronic module 82. Said electronic module 82 then calculates a value 108 of the tightening tension in rod 14, 314, 414, corresponding to said ultrasonic waves received.

Then, the operator dissociates the probe 18, 118, 218, 318, 418, 518, 618 and the rod 14, 314, 414, so as to get back said probe.

According to a second embodiment, the process of implementing device 10, 310, 410 aims to achieve the structural connection 36, 436 by installing in fastener 12, 312, 412 a tightening tension corresponding to a target value.

According to the second embodiment, the rod 14, 314, 414 is assembled to the structural elements 38 with the head 34, 334, 434 coming into contact with the first face 40; and nut 16 is engaged on the threaded portion 30 while maintaining a non-zero distance from the second face 42.

Probe 18, 118, 218, 318, 418, 518, 618 is then assembled to rod 14, 314, 414, as described above. More precisely, in the embodiments of FIGS. 1 to 3, the probe 18, 118, 218 is assembled at the recess 24 of rod 14, arranged on the side of the second face 42 of the structural elements 38; and in the embodiments of FIGS. 4 to 7, the probe 318, 418, 518, 618 is assembled at the head 334, 434 of the rod, disposed on the side of the first face 40 of said structural elements

Then a tightening step of the nut 16 is implemented, so as to install a tightening tension in the rod 14, 314, 414. At the same time, the previously described measurement phase 100 is implemented in order to calculate a value 108 of said tightening tension. During the tightening step of nut 16, the rod 14, 314, 414 is held fixed in rotation and translation with respect to the structural elements 38.

The tightening of nut 16 is then stopped when said value 108 reaches the target value of tightening tension.

Probe 18, 118, 218, 318, 418, 518, 618 is then dissociated from rod 14, 314, 414.

In the second mode of execution of the process, probe 18, 118, 218 of device 10 in FIGS. 1 to 3 is preferentially incorporated into a tool or an installation automate (not shown), which first assembles said probe 18, 118, 218 to the recess 24 of rod 14, then in a second step tightens the nut 16. A similar robotic installation is described in the above-mentioned application FR 22 12289.

In device 410 in FIGS. 5 to 7, as shown above, tightening devices as described in document WO2024110510 may be used as probes 418, 518, 618. In the second embodiment of the process, such probe 418, 518, 618 is separate from the nut tightening tool but is electronically connected to said tightening tool.

1. Device for controlling the tightness of a fastener, said device comprising:
a rod, extending along a first axis; the rod comprising an assembly element, arranged on a first radial surface of said rod;
the rod comprising a first and a second flat faces, perpendicular to the first axis and disposed respectively at a first and second ends of said rod;
an assembly device, capable of joining to the assembly element of the rod to form the fastener; and
a probe comprising:
a probe body, comprising a first frontal face, capable of coming into contact with the first or the second flat face of the rod; and
a transducer, integral to the probe body, said transducer being capable of sending and/or receiving ultrasound waves;
the rod having a first locking element; and
the probe having a second locking element, capable of mechanically cooperating with said first locking element, so as to block an axial displacement of the probe with respect to the rod and to apply the first frontal face of the probe body against the first or the second flat surface of the rod.

2. A control device according to claim 1, further comprising a solid coating layer on the first frontal face of the probe body, said coating being capable of improving acoustic transmission between the probe body and the rod.

3. A control device according to claim 1, wherein the rod comprises an enlarged head disposed at the first end of said rod.

4. A control device according to claim 3, wherein: the assembly element of the rod is a threaded portion, disposed at the second end of said rod; and the assembly device is a nut.

5. A control device according to claim 1, wherein the probe body extends along a second axis between the first and a second frontal faces, each of said frontal faces being flat and perpendicular to the second axis, the transducer being in contact with the second frontal face.

6. A control device of claim 5, wherein the transducer comprises a piezoelectric sensor, attached to the second frontal face of the probe body.

7. A control device according to claim 5, wherein the second frontal face of the probe body is formed by the bottom of a hollowed part provided in the probe body.

8. A control device according to claim 1, wherein the probe further comprises: a tubular support, comprising an end opened to an axial cavity; and a compression spring, disposed in said axial cavity, a first and a second end of the spring being attached respectively to the probe body and to the tubular support; the probe body being mobile in translation in the axial cavity of the tubular support; and in which the second locking element is carried by the tubular support.

9. A control device according to claim 1, wherein: the rod has an axial recess disposed at one of the first and second ends of said rod; the first or second flat face of the rod is formed by a bottom of said axial recess; and the first locking element is carried by the axial recess.

10. A control device according to claim 9, wherein the first and second locking elements are an external thread and an internal thread, respectively.

11. A control device according to claim 10, wherein the external thread of the probe is carried by the probe body.

12. A control device of claim 9, wherein the first and second locking elements comprise a bayonet notch and a bayonet lug, respectively.

13. A control device according to claim 8, wherein:
the rod has an axial recess disposed at one of the first and second ends of said rod; the first or second flat face of the rod is formed by a bottom of said axial recess; and the first locking element is carried by the axial recess;
the first and second locking elements comprise respectively: an internal groove, provided in the axial recess of the rod; and at least one locking lug, provided on the tubular support of the probe;
the tubular probe support comprises at least one flexible tab, the flexible tabs carrying the locking lugs;
the probe further comprises a sleeve arranged around the tubular support and capable of sliding axially with respect to said tubular support, the sleeve comprising at least one through hole; and
the tubular support and the sleeve are movable between a retracted conformation, in which at least one locking lug is disposed inside the sleeve, and an extended conformation, in which the or each locking lug is disposed in the through hole of the sleeve and protruding radially from said sleeve;
wherein the device is configured so that, in the extended conformation, the locking lugs are capable of being disposed in the inner groove of the axial recess of the rod, so as to axially lock the probe in said axial recess.

14. A control device according to claim 3, wherein the enlarged head of the rod comprises a second external radial surface, arranged around the first axis; said radial surface comprising the first locking element and the first anti-rotation elements.

15. A control device according to claim 14, wherein:
the probe further comprises: a tubular support, comprising an end opened to an axial cavity; and a compression spring, disposed in said axial cavity, a first and a second end of the spring being attached respectively to the probe body and to the tubular support; the probe body being mobile in translation in the axial cavity of the tubular support; and in which the second locking element is carried by the tubular support;
the open end of the tubular support of the probe comprises second anti-rotation elements, capable of mechanically cooperating with the first anti-rotation elements to lock the rod in rotation with respect to said open end; and
the second locking element comprises at least one movable element radially with respect to said open end, between a locked position, in which said moving element mechanically cooperates with the first locking element, and an unlocked position, in which said moving element and said first locking element are away from each other.

16. A method for testing the tightening tension of a fastener, carried out by means of a control device according to claim 1, said method comprising:
an assembly phase, comprising: the assembly of the rod and the assembly device with structural elements to form the fastener, a tightening tension being applied in the rod; and assembling the second locking element of the probe with the first locking element of the rod, so as to lock the probe axially with respect to the rod and to apply the first frontal face of the probe body against one of the first and second flat faces of the rod with a non-zero pressure; and
a phase for measuring the tightening tension, comprising: the generation, by the transducer, of the ultrasonic waves emitted; the reception, by said transducer, of ultrasonic waves reflected by the other of the first and second flat surfaces of the rod; and the processing of the ultrasonic waves received to calculate the tightening tension in the rod.

17. A testing method according to claim 16, wherein:
the rod comprises an enlarged head disposed at the first end of said rod;
the assembly element of the rod is a threaded portion, disposed at the second end of said rod; and the assembly device is a nut; and
the assembly of the rod and the assembly device comprises a step for tightening the nut on the threaded portion of the rod; the tightening tension measurement phase is carried out simultaneously with said tightening step; and the tightening of the nut is stopped when a target value of the tightening tension is reached.
